(19) United States
(12) Patent Application Publication
(10) Pub. No.: US 2015/0073846 A1
(43) Pub. Date: Mar. 12, 2015

(54) OBTAINING A PRODUCT VIA A REPOSITORY IN AN ORGANIZATION WITH OBTAINMENT UNITS

(71) Applicant: Hewlett-Packard Development Company, L.P., Houston, TX (US)

(72) Inventors: Filippo Balestrieri, Mountain View, CA (US); Bernardo Huberman, Palo Alto, CA (US); Thomas E. Sandholm, Sunnyvale, CA (US)

(73) Assignee: Hewlett-Packard Development Company, L.P., Houston, TX (US)

(21) Appl. No.: 14/025,044

(22) Filed: Sep. 12, 2013

(51) Int. Cl. G06Q 40/00; G06Q 10/08; G06Q 10/06

(52) U.S. Cl. CPC G06Q 40/12; G06Q 10/0631; G06Q 10/06311; G06Q 10/087
USPC 705/7.13; 705/7.12

(57) ABSTRACT

A purchase order is received by an entity associated with an organization for a product to be obtained via a vendor, wherein the product has a value in external-obtainment units. The product is inventoried in a repository of the organization, wherein the product is obtainable via the repository of the organization with internal-obtainment units. The product is allocated to a number of entities associated with the organization.

### BACKGROUND

Various products may be utilized by an organization. These products may be obtained from a vendor by the organization. The organization may have a budget for obtaining these products.

### BRIEF DESCRIPTION OF THE DRAWINGS

FIG. 1 is a diagram of an example of an environment wherein examples of the present disclosure may be utilized.

FIGS. 2A-2B illustrate examples of systems according to the present disclosure.

FIG. 3 illustrates a flow chart of an example of a method according to the present disclosure.

### DETAILED DESCRIPTION

Examples of the present disclosure provide systems and methods that can increase efficiency of budget spending for an organization, as compared to other organizational budgeting and/or accounting systems and methods. This increase in the efficiency of budget spending may be realized in a reduction of purchases of underutilized products and/or an increased usage of products in the organization's possession.

In the following detailed description of the present disclosure, reference is made to the accompanying drawings that form a part hereof, and in which is shown by way of illustration how examples of the disclosure may be practiced. These examples are described in sufficient detail to enable those of ordinary skill in the art to practice the examples of this disclosure, and it is to be understood that other examples may be used and the process, electrical, and/or structural changes may be made without departing from the scope of the present disclosure.

The figures herein follow a numbering convention in which the first digit or digits correspond to the drawing figure number and the remaining digits identify an element or component in the drawing. Elements shown in the various examples herein can be added, exchanged, and/or eliminated so as to provide a number of additional examples of the present disclosure.

In addition, the proportion and the relative scale of the elements provided in the figures are intended to illustrate the examples of the present disclosure, and should not be taken in a limiting sense. As used herein, “a number of” an entity, an element, and/or feature can refer to one or more of such entities, elements, and/or features.

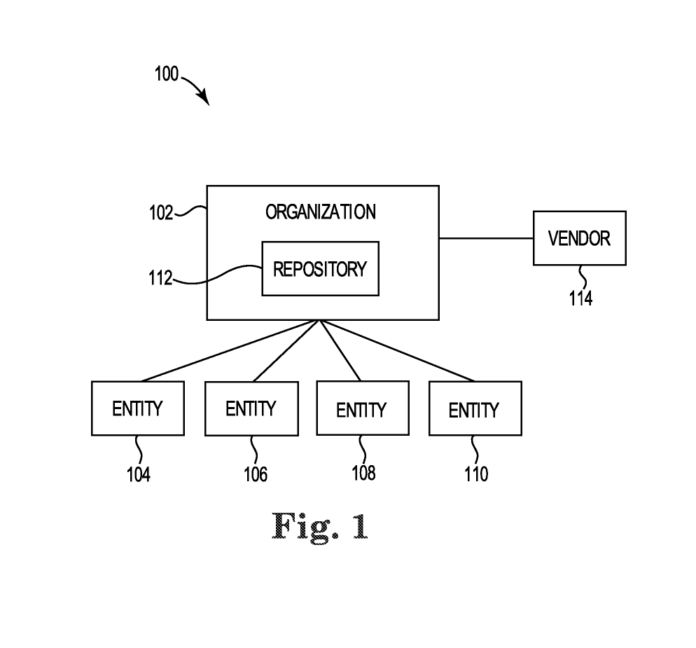

FIG. 1 is a diagram of an example of an environment 100 wherein examples of the present disclosure may be utilized. As illustrated in FIG. 1, the environment 100 can include an organization 102. As an example, the organization 102 can be a business organization, e.g., the organization 102 can provide goods, services, or both to consumers or a tertiary business in exchange for compensation. The organization 102 may be a sole proprietorship, a corporation, a partnership, an S-corporation, or a non-profit organization, for example.

The organization 102 can have number of entities 104, 106, 108, 110 associated with the organization 102. While four entities, entity 104, entity 106, entity 108, and entity 110, are illustrated in FIG. 1, examples of the present disclosure are not so limited and the organization 102 can include different numbers of entities. Each entity 104, 106, 108, 110 can be a person, department, team, or other group associated with the organization 102. Some examples of the present disclosure provide that the entities 104, 106, 108, 110 are employees of the organization 102. As illustrated in FIG. 1, the organization 102 can include a repository 112, as discussed further herein according to examples of the present disclosure. For instance, some examples of the present disclosure provide that a product can be obtained via the repository 112 of the organization 102 with internal-obtainment units, as discussed further herein.

The organization 102 may have a budget, e.g., an expenditure budget, such as a quantified expression of spending for a defined interval of time. In other words, a budget may refer to an amount of money that is committed to expenditures of a particular kind. The budgetary commitment can help to control expenses of the organization and/or or provide predictability to the organization's expenditures. Effectiveness of the budgetary commitment can be increased when implemented such that transactions associated with the budgetary commitment can be monitored and/or verified. As discussed herein, examples of the present disclosure can utilize external-obtainment units and internal-obtainment units to increase effectiveness of the budgetary commitment, e.g., by monitoring and/or verifying transactions, and facilitate dynamic adjustments of the budget over time.

Some examples of the present disclosure may be utilized for increasing the efficiency of spending for various types of budgets, such as an Information Technology (IT) budget, among others. An IT budget can include organizational expenditures for products, e.g., IT products, such as software applications, licenses, and renewals, among other products.

As illustrated in FIG. 1, the environment 100 can include a vendor 114. The vendor 114 can provide goods, services, or both to the organization 102 in exchange for compensation, e.g., legal tender. As an example, the vendor 114 can provide software applications, licenses, and renewals, among other products to the organization 102. While a single vendor 114 is illustrated in FIG. 1, examples of the present disclosure are not so limited and the organization 102 can obtain products from different numbers of vendors.

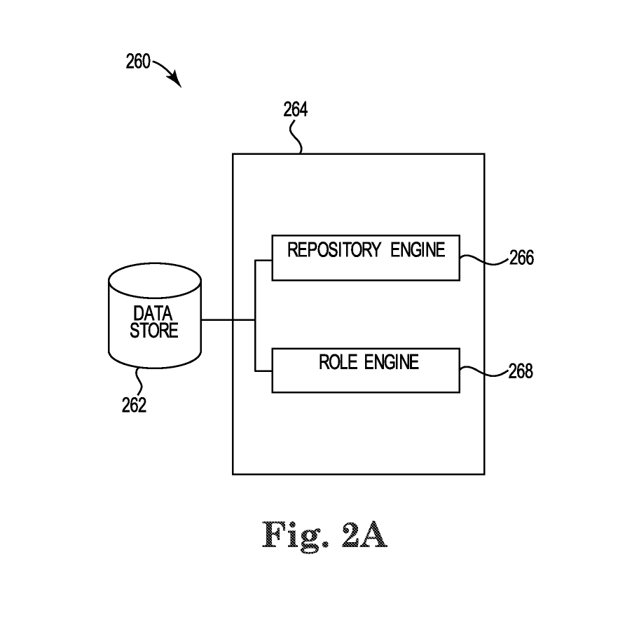

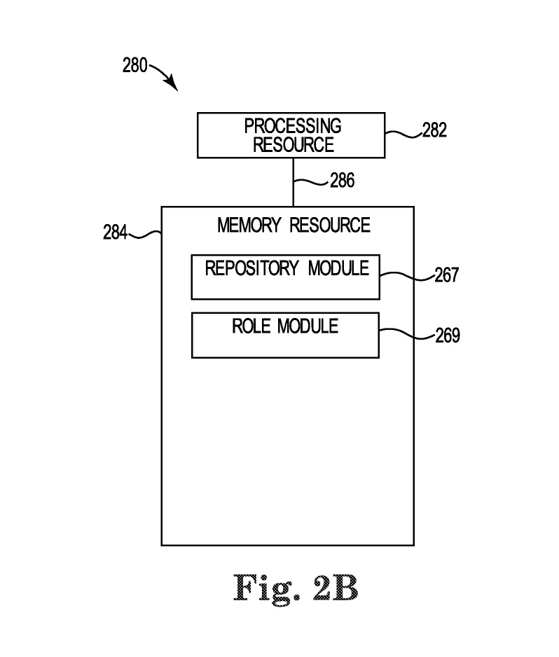

FIGS. 2A-2B illustrate examples of systems 260, 280 according to the present disclosure. The system 260 can include a data store 262, processing system 264, and/or a number of engines 266, 268. The processing system 264 can be in communication with the data store 262 via a communication link, and can include the number of engines, e.g., repository engine 266, role engine 268, etc. The processing system 264 can include additional or fewer engines than illustrated to perform the various functions described herein.

The number of engines can include a combination of hardware and programming that is configured to perform a number of functions described herein, e.g., inventory a product purchased from a vendor, wherein the product is obtainable from a repository of an organization with internal-obtainment units, assign a number of roles to a number of entities associated with an organization, wherein the number of roles comprises a first role and a second role, wherein the first role is authorized to assign the number of roles to entities associated with the organization and the second role is authorized to submit a purchase order for the product obtained via the vendor with external-obtainment units that are converted to legal tender and obtain the product from the repository of the organization with internal-obtainment units, etc. The programming can include program instructions, e.g., software, firmware, etc., stored in a memory resource, e.g., computer readable medium, machine readable medium, etc., as well as hard-wired program, e.g., logic.

The repository engine 266 can include hardware, programming, and/or a combination of hardware and programming to inventory a product obtained from a vendor, wherein the product is obtainable from a repository of an organization with internal-obtainment units. The repository engine 266 can include hardware, programming, and/or a combination of hardware and programming to perform other functions described herein.

As mentioned, examples of the present disclosure provide that products can be inventoried via the repository. For instance, products obtained by the organization can be stored and/or listed in the repository to be obtained by an entity associated with the organization, e.g., the repository may function as a store. Inventorying products obtained by the organization can increase accessibility of products to entities, e.g., employees throughout an organization. Additionally, inventorying products obtained by the organization can allow some entities associated with the organization to utilize products purchased by another entity associated with the organization. This may provide that some entities benefit from the expertise, e.g., by having, access to purchase particular products via the repository, of another entity, e.g., having greater competence in a particular area.

The role engine 268 can include hardware, programming, and/or a combination of hardware and programming to assign a number of roles to a number of entities associated with an organization. The role engine 268 can include hardware, programming, and/or a combination of hardware and programming to perform other functions described herein.

The number of roles can correspond to a hierarchy, e.g., where different roles, which correspond to different levels of the hierarchy, can have different authorizations. Some examples of the present disclosure provide that authorizations can correspond to external-obtainment units and/or internal-obtainment units.

External-obtainment units, which may also be referred to as convertible points among other terms, can function as a first currency of the organization. A budget of the organization can be converted from legal tender, e.g., dollars, into external-obtainment units. Some examples of the present disclosure provide that a budget of the organization, e.g., an amount of money that is committed to expenditures of a particular kind, can be equivalent to a quantity of external-obtainment units, where the quantity of external-obtainment units is distributed to entities associated with the organization. As an example, the legal tender and the external-obtainment units can have a one-to-one conversion rate, e.g., where each budget dollar is converted to a corresponding external-obtainment unit on a one-to-one basis. However, examples are not so limited and other conversion rates may be utilized. Some examples of the present disclosure provide that the conversion rate of legal tender to external-obtainment units is variable. For instance, when a budget of the organization is modified, e.g., increased or decreased, the conversion rate of legal tender to external-obtainment units can be varied, e.g. to correspond to the budget modification. By providing that the conversion rate of legal tender to external-obtainment units can be varied, modifications to the budget can be efficiently implemented.

Some examples of the present disclosure provide that external-obtainment units are transferrable between different entities associated with the organization. For instance, some examples of the present disclosure provide that a particular role of the number of roles can transfer external-obtainment units to any of the number of roles.

Some examples of the present disclosure provide that external-obtainment units may expire. For instance, the external-obtainment units may be utilized only for a given interval of time, e.g., the given interval of time may correspond to the interval of time of the budget of the organization, such as a fiscal quarter or a fiscal year.

Entities associated with the organization having proper authorization may submit a purchase order, e.g., to the repository, for a product to be obtained via a vendor. The purchase order can indicate the price of the product in external-obtainment units that can be converted into legal tender for transfer to the vendor in exchange for the product. In other words, an entity associated with the organization having proper authorization can indicate a product that is desired for purchase and submit a corresponding amount of external-obtainment units to the repository. The repository can convert the corresponding amount of external-obtainment units to legal tender that can be transferred to the vendor to obtain the product.

Internal-obtainment units, which may also be referred to as simple points among other terms, can function as a second currency of the organization. Internal-obtainment units may be used by entities, having proper authorization, associated with the organization to obtain a product via the repository of the organization. Internal-obtainment units, in contrast to external-obtainment units, can be utilized to regulate allocation of resources within an organization. Some examples of the present disclosure provide that internal-obtainment units are transferrable between different entities associated with the organization. For instance, some examples of the present disclosure provide that a particular role of the number of roles can transfer internal-obtainment units to any of the number of roles. Some examples of the present disclosure provide that internal-obtainment units may expire. For instance, the internal-obtainment units may be utilized only for a given interval of time, e.g., the given interval of time may correspond to the interval of time of the budget of the organization, such as a fiscal quarter or a fiscal year.

Some examples of the present disclosure provide that obtaining a product via the repository can include an entity associated with the organization retaining the product for an interval of time. In other words, the entity that obtained the product does not retain the product indefinitely, e.g., the product is allocated temporarily. For example, for a particular number of internal-obtainment units an entity associated with the organization may retain the product for a specified interval of time, e.g., an hour, a day, a week, a month, a fiscal quarter, or a fiscal year, among other specified intervals of time. Different products may be obtained for different amounts of internal-obtainment units and may be retained for different specified intervals of time. As discussed further herein, following an interval of time for which the product is retained, the product can be returned to the repository and the internal-obtainment units can be returned, e.g., the internal-obtainment units can be fully rebated/refunded. The return of the product can be initiated by the entity that has obtained the product or may be implemented automatically at the end of the period. Some examples of the present disclosure provide that a default rule can be applied, where the rule stipulates that the product stays with an entity that obtained it and the internal-obtainment units are not rebated; then, after a specified interval of time, the rule stipulates that the product is returned to the repository and the internal-obtainment units are rebated to the entity.

As mentioned, examples of the present disclosure can provide an increase in efficiency of budget spending. For example, obtaining a particular product for a given period of time can be determined through an auction amongst different entities associated with the organization. The different entities have an opportunity to express urgency to obtain a particular product through internal-obtainment units bids placed for the particular product, e.g., where higher bids can correspond to greater urgency.

Also because products are temporarily allocated, as urgency to obtain a particular product deceases amongst entities associated with the organization, an entity may be re-obtain the product for a subsequent period of time for fewer internal-obtainment units relative to a first instance of obtaining the product. For example, the obtaining a particular product for a given period of time can be determined through an auction amongst different entities associated with the organization or by an entity paying a posted price. If an entity has obtained a particular product when the product was in high demand, e.g., the product was obtained for a high bid or a high posted price, and demand for the product has decreased, the entity may be able to re-obtain the product for a subsequent interval of time with a bid that is lower than the previous bid or by paying a posted price that is lower than the previously paid posted price.

The number of roles can include a first role, which may be referred to as an administrator role. Some examples of the present disclosure provide that the first role can function as a manager of the repository. For instance, the first role can make and/or delegate decisions. The first role can be authorized to assign roles, e.g., of the number of roles, to entities associated with the organization; set a conversion rate, e.g., a conversion rate of legal tender into external-obtainment units; set a total number of internal-obtainment units available to entities associated with the organization; distribute external-obtainment units among entities associated with the organization; distribute internal-obtainment units among entities associated with the organization; set authorizations for the number of roles; determine an allocation process for particular products, e.g., vending a particular product by auction or vending a particular product by a posted price; determine and/or apply scoring to an allocation process; set a given period for which external-obtainment units may be utilized before expiration, set a given period for which internal-obtainment units may be utilized before expiration, among others. Some examples of the present disclosure provide that the first role can be associated with a senior employee of the organization, such as a Chief Information Officer (CIO) or an Information Technology (IT) Director, among others. Some examples of the present disclosure provide that a single entity associated with the organization fulfills the first role; however examples are not so limited. Some examples of the present disclosure provide that the first role can be associated with a top level of the hierarchy. For example, the first role can be hierarchically above other roles of the number of roles.

The number of roles can include a second role. Some examples of the present disclosure provide that the second role can be associated with a number of entities associated with the organization, e.g., there can be a plurality of second roles. Some examples of the present disclosure provide that the second role can be authorized to submit a purchase order for a product to be obtained via a vendor. The second role can provide external-obtainment units that are converted to legal tender to purchase the product from the vendor. The second role can be authorized to obtain a product from the repository of the organization with internal-obtainment units. The second role can be authorized to transfer external-obtainment units, e.g. to a third role and/or a fourth role, as discussed further herein. The second role can be authorized to transfer internal-obtainment units, e.g. to a third role, a fourth role, and/or a fifth role, as discussed further herein. Some examples of the present disclosure provide that the second role can be associated with a level of the hierarchy that is immediately below the first role. For example, the second role can be hierarchically below the first role while being hierarchically above other roles of the number of roles.

The number of roles can include a third role. Some examples of the present disclosure provide that the third role can be associated with a number of entities associated with the organization, e.g., there can be a plurality of third roles.

Some examples of the present disclosure provide that the third role can be authorized to submit a purchase order for a product to be obtained via a vendor. The third role can provide external-obtainment units that are converted to legal tender to purchase the product from the vendor. The third role can be authorized to obtain a product from the repository of the organization with internal-obtainment units. The third role can be authorized to transfer internal-obtainment units to other roles of the number of roles and/or another entity having the third role. Some examples of the present disclosure provide that the third role is not authorized to transfer external-obtainment units to other roles of the number of roles. Some examples of the present disclosure provide that the third role can be associated with a level of the hierarchy that is immediately below the second role. For example, the third role can be hierarchically below the second role while being hierarchically above other roles of the number of roles.

The number of roles can include a fourth role. Some examples of the present disclosure provide that the fourth role can be associated with a number of entities associated with the organization, e.g., there can be a plurality of fourth roles.

Some examples of the present disclosure provide that the fourth role can be authorized to submit a purchase order for a product to be obtained via a vendor. The fourth role can provide external-obtainment units that are converted to legal tender to purchase the product from the vendor. The fourth role can be authorized to obtain a product from the repository of the organization with internal-obtainment units. Some examples of the present disclosure provide that the fourth role is not authorized to transfer external-obtainment units to other roles of the number of roles. Some examples of the present disclosure provide that the fourth role is not authorized to transfer internal-obtainment units to other roles of the number of roles. Some examples of the present disclosure provide that the fourth role can be associated with a level of the hierarchy that is immediately below the third role. For example, the fourth role can be hierarchically below the first role, the second role, and the third role, while being hierarchically above another role of the number of roles.

The number of roles can include a fifth role. Some examples of the present disclosure provide that the fifth role can be associated with a number of entities associated with the organization, e.g., there can be a plurality of fifth roles.

Some examples of the present disclosure provide that the fifth role can be authorized to obtain a product from the repository of the organization with internal-obtainment units. Some examples of the present disclosure provide that the fifth role is not authorized to transfer external-obtainment units to other roles of the number of roles. Some examples of the present disclosure provide that the fifth role is not authorized to utilize external-obtainment units, e.g., to obtain a product via a vendor. Some examples of the present disclosure provide that the fifth role is not authorized to transfer internal-obtainment units to other roles of the number of roles. Some examples of the present disclosure provide that the fifth role can be associated with a level of the hierarchy that is immediately below the fourth role. For example, the fifth role can be hierarchically below the first role, the second role, the third role, and the fourth role.

As mentioned, internal-obtainment units may be used by entities, having proper authorization, associated with the organization to obtain a product from the repository of the organization. Some examples of the present disclosure provide that a product may be temporarily allocated to entities associated with the organization. For instance, some examples of the present disclosure provide that a product may be auctioned to entities associated with the organization. The auction winner obtains the product for a given interval of time. Some examples of the present disclosure provide that a product may be temporarily allocated without an auction. For instance, some examples of the present disclosure provide that a product may be obtained for a given interval of time by paying a specified quantity, e.g., a posted price, of internal-obtainment units. A posted price algorithm can be utilized to determine the posted price. A number of factors, as discussed herein, may be utilized by the posted price algorithm.

Some examples of the present disclosure provide that each transaction associated with the repository can be recorded, e.g., registered. For example, the quantity of internal-obtainment units utilized to obtain products can be recorded, e.g., via the repository. Recording the quantity of internal-obtainment units utilized to obtain products may be part of a verification of the product obtainment that is discussed further herein. Recording the quantity of internal-obtainment units utilized to obtain products can help enable a rebate upon return of the product to the repository, as discussed further herein. Similarly, a quantity of external-obtainment units utilized to obtain products via a vendor can be recorded.

Some examples of the present disclosure provide that the auction is an open auction, e.g., where auction participants openly bid against one another. Some examples of the present disclosure provide that a product may be concurrently obtained by a plurality of the number entities associated with the organization. For example, the product may have a number of similar licenses associated therewith, where each of the number of licenses can be purchased by an entity associated with the organization. Some examples of the present disclosure provide that a product may be obtained, for a particular interval of time, by only one of the number entities associated with the organization.

For examples of the present disclosure, a variety of auctions may be utilized. For instance, the auction may be a price-only auction, e.g., where a highest bidder of internal-obtainment units wins the auction, or a scoring auction, e.g., where a bid of internal-obtainment units is considered in connection with a number of factors in order to determine an auction winner. Some examples of the present disclosure may utilize a scoring rule. For instance, a particular entity may be favored when bidding is below a threshold level and another entity may be favored when bidding is above the threshold level.

The auction can be an ascending price auction, e.g., where each subsequent bid is a greater quantity of internal-obtainment units than a respective previous bid. As an example, the ascending price auction can end, i.e., a product is obtained, when no bidder is willing to bid further at which point the highest bidder pays the winning bid of internal-obtainment points to the repository in exchange for the product,

The auction can be a descending price auction, e.g., where an initial purchase price for a product is set and therefrom the price is lowered until a purchaser is willing to accept a requested price. As an example, the descending price auction can end, i.e., a product is obtained, when a first bidder is willing to pay a quantity of internal-obtainment units requested by the repository for obtaining of the product. Some examples of the present disclosure provide that another type of auction may be utilized.

Some examples of the present disclosure provide a verification of product obtainment. For example, the verification can determine if an entity that is prepared to obtain the product, e.g., an entity that has placed a winning auction bid or an entity that has indicated a willingness to pay a posted price, is entitled to obtain the product. For instance, the verification can determine if the entity that is prepared to obtain the product, has available a quantity of internal-obtainment units equal to or exceeding the winning auction bid or the posted price. Some examples of the present disclosure provide that if the entity has insufficient internal-obtainment units then that entity will be unable to obtain the product, which may then be further vended to entities associated with the organization.

Similarly, the verification can determine if an entity has available a quantity of external-obtainment units equal to or exceeding an amount of external-obtainment units sufficient to obtain a product from a vendor. Some examples of the present disclosure provide that if the entity has insufficient external-obtainment units then the product will not be obtained from the vendor.

Some examples of the present disclosure provide that an inventoried product that is obtainable from the repository can be prioritized. For example, a product may be auctioned to entities associated with the organization such that the auction is biased to favor a particular entity. For instance, a product may be auctioned to a number of entities where a first of the number of entities can obtain the product for a first quantity of internal-obtainment units and a second entity can obtain the product for a second quantity of internal-obtainment units, such that the first quantity is different than the second quantity. The auction is biased in favor of the entity having the lower quantity of internal-obtainment units needed to obtain the product. In other words, repository prices for particular products can be entity specific. Biasing the auction to favor of a particular entity can help to ensure that resources, e.g., products that are obtainable from the repository, are allocated to promote objectives of the organization.

An entity's urgency to utilize a product, an entity's technical competence regarding utilization of a product, and/or an entity's productivity regarding utilization of a product can be factors, among other factors, used to determine what price a particular entity must pay to obtain a particular product from the repository. For instance, these factors, among others, may be utilized by the scoring rule and/or the posted price algorithm. However, examples of the present disclosure are not so limited and other factors may be utilized, alone or in conjunction with the factors discussed herein, e.g., by the scoring rule and/or the posted price algorithm. For example, such factors may be inputted in the price algorithm or the scoring rule by entities at high hierarchical levels, or by entities selected by the entity holding the first role.

As mentioned, an entity that has obtained a product via the repository, for a number of internal-obtainment units, may retain the product for an interval of time, e.g., in order to utilize the product for a particular function. When the interval of time is expired, the product can be returned to the repository. After the product is returned to the repository, the entity that obtained the product and returned the product can receive a rebate, e.g., a rebate equal to the quantity of the internal-obtainment units utilized to obtain the product. In other words, the internal-obtainment units utilized to obtain the product can be returned to the obtainer of the product after the obtainer has retained the product for an interval of time and thereafter returned the product to the repository. The returned internal-obtainment units are utilizable for a subsequent obtainment from the repository of the organization, e.g., the returned internal-obtainment units can be used to obtain another product. Providing that the internal-obtainment units are reusable can help to regulate the purchase and/or management, e.g., transfers of products from one entity to another, of the products.

An entity that has obtained a product via a vendor, e.g., where the entity provides external-obtainment units to the repository that are converted to legal tender for transfer to the vendor in exchange for the product, may receive a rebate of internal-obtainment units after the product is returned to the repository. Internal-obtainment units that are rebated for external-obtainment units can have various conversion rates. For instance, for every external-obtainment unit there may be a rebate of two internal-obtainment units; however examples of the present disclosure are not so limited and various conversion rates may be utilized. Some examples of the present disclosure provide that the repository and/or the first role can set the conversion rates for internal-obtainment units that are rebated for spent external-obtainment units. For example, the conversion rate from external- to internal-obtainment units may be determined by the entity holding the first role.

Some examples of the present disclosure provide that external-obtainment units can be converted into internal purchase-units at a presently implemented conversion rate at any point of time. Some examples of the present disclosure provide that internal-obtainment units are not convertible to external-obtainment units.

Utilizing the external-obtainment units and the internal-obtainment units can help to decrease underutilization of products. For instance, due to the limited quantities of the external-obtainment units and the internal-obtainment units, an entity that has obtained a product, but has underutilized that product, make be encouraged to return the product to the repository in order to receive a rebate of internal-obtainment units, which the entity can use to obtain a different product while providing a different entity an opportunity to obtain the returned product.

Inventorying products purchased by the organization via the repository can help facilitate that the products satisfy safety and/or security criteria. The external purchase, internal purchase, and internal usage of the products can be readily obtained via the repository, e.g., by a compliance officer of the organization.

FIG. 2B illustrates a diagram of an example of a system 280 according to the present disclosure. The system 280 can utilize software, hardware, firmware, and/or logic to perform a number of functions described herein.

The system 280 can be any combination of hardware and program instructions configured to share information. The hardware, for example can include a processing resource 282 and/or a memory resource 284, e.g., computer-readable medium (CRM), machine readable medium (MRM), database, etc. A processing resource 282, as used herein, can include any number of processors capable of executing instructions stored by a memory resource 284. Processing resource 282 may be integrated in a single device or distributed across multiple devices. The program instructions, e.g., computer-readable instructions (CRI), can include instructions stored on the memory resource 284 and executable by the processing resource 282 to implement a desired function, e.g., inventory a product obtained from a vendor, wherein the product is obtainable from a repository of an organization with internal-obtainment units, assign a number of roles to a number of entities associated with an organization, etc.

The memory resource 284 can be in communication with a processing resource 282. A memory resource 284, as used herein, can include any number of memory components capable of storing instructions that can be executed by processing resource 282. Such memory resource 284 can be a non-transitory CRM or MRM. Memory resource 284 may be integrated in a single device or distributed across multiple devices. Further, memory resource 284 may be fully or partially integrated in the same device as processing resource 282 or it may be separate but accessible to that device and processing resource 282. Thus, it is noted that the system 280 may be implemented on a participant device, on a server device, on a collection of server devices, and/or a combination of the user device and the server device.

The memory resource 284 can be in communication with the processing resource 282 via a communication link, e.g., a path, 286. The communication link 286 can be local or remote to a machine, e.g., a computing device, associated with the processing resource 282. Examples of a local communication link 286 can include an electronic bus internal to a machine, e.g., a computing device, where the memory resource 284 is one of volatile, non-volatile, fixed, and/or removable storage medium in communication with the processing resource 282 via the electronic bus.

A number of modules, e.g., modules 267, 269, can include CRI that when executed by the processing resource 282 can perform a number of functions, e.g., functions described herein. The number of modules can be sub-modules of other modules. For example, repository module 267 and role module 269 can be sub-modules and/or contained within the same computing device. In another example, the number of modules can comprise individual modules at separate and distinct locations, e.g., CRM, etc.

Each of the number of modules can include instructions that when executed by the processing resource 282 can function as a corresponding engine as described herein. For example, repository module 267 can include instructions that when executed by the processing resource 282 can function as the repository engine 266. As another example, the role module 269 can include instructions that when executed by the processing resource 282 can function as the role engine 268.

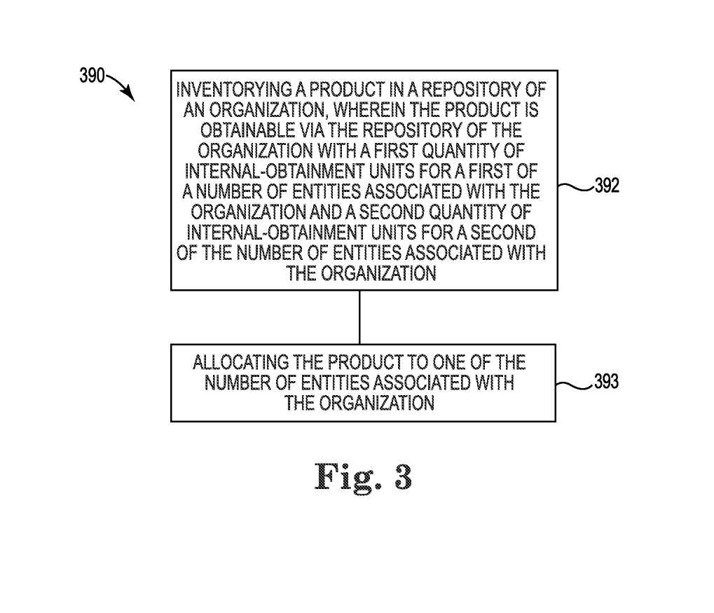

FIG. 3 illustrates a flow chart of an example of a method 390 according to the present disclosure. At 392, the method 390 can include inventorying a product in a repository of an organization. The product can be obtainable via the repository of the organization with a first quantity of internal-obtainment units for a first of a number of entities associated with the organization and a second quantity of internal-obtainment units for a second of the number of entities associated with the organization

At 393, the method 390 can include allocating the product to one of the number of entities associated with the organization. Examples of the present disclosure provide that the first quantity of internal-obtainment units is different than the second quantity of internal-obtainment units.

The examples herein provide a description of the applications and use of the systems and methods of the present disclosure. Since many examples can be made without departing from the spirit and scope of the system and method of the present disclosure, this specification sets forth some of the many possible example configurations and implementations.

What is claimed:

1. A non-transitory computer-readable medium storing a set of instructions executable by a processing resource to:
receive a purchase order by an entity associated with the organization for a product to be obtained via a vendor, wherein the product has a value in external-obtainment units;
inventory the product in a repository of an organization, wherein the product is obtainable via the repository of the organization with internal-obtainment units; and
allocate the product to a number of entities associated with the organization.

2. The non-transitory computer-readable medium of claim 1, wherein the instructions are executable to return the internal-obtainment units from the repository to an obtainer of the product after the obtainer has returned the product to the repository.

3. The non-transitory computer-readable medium of claim 2, wherein the returned internal-obtainment units are utilizable for a subsequent obtainment from the repository of the organization.

4. The non-transitory computer-readable medium of claim 1, wherein the product is allocated by a scoring auction.

5. The non-transitory computer-readable medium of claim 1, wherein the product is allocated by a posted price.

6. The non-transitory computer-readable medium of claim 1, wherein the instructions are executable to obtain the product via the vendor with legal tender that has been converted from external-obtainment units.

7. The non-transitory computer-readable medium of claim 1, wherein the external-obtainment units are utilizable for a first period of time and the internal-obtainment units are utilizable for a second period of time.

8. A system, comprising a processing resource in communication with a non-transitory computer-readable medium having instructions executable by the processing resource to implement:
a repository engine to inventory a product obtained via a vendor, wherein the product is obtainable via a repository of an organization with internal-obtainment units; and
a role engine to assign a number of roles to a number of entities associated with an organization, wherein the number of roles comprises a first role and a second role, wherein the first role is authorized to assign the number of roles to entities associated with organization and the second role is authorized to submit a purchase order for the product obtained via the vendor with external-obtainment units that are converted to legal tender and obtain the product from the repository of the organization with internal-obtainment units.

9. The system of claim 8, wherein the first role is hierarchically above the second role and the number of roles comprises a third role that is hierarchically below the second role, a fourth role that is hierarchically below the third role, and a fifth role that is hierarchically below the fourth role.

10. The system of claim 9, wherein the second role is authorized to transfer external-obtainment units and internal-obtainment units to the third role, the third role, the fourth role, and the fifth role.

11. The system of claim 9, wherein the second role is authorized to transfer internal-obtainment units to the third role, the fourth role, and the fifth role.

12. The system of claim 9, wherein the third role is authorized to submit a purchase order for the product obtained via the vendor with external-obtainment units that are converted to legal tender and obtain the product from the repository of the organization with internal-obtainment units.

13. The system of claim 9, wherein the fourth role is authorized to obtain the product from the repository of the organization with internal-obtainment units and the fifth role is not authorized to utilize external-obtainment units.

14. A method for budget implementation, the method comprising:
inventorying a product in a repository of an organization, wherein the product is obtainable via the repository of the organization with a first quantity of internal-obtainment units for a first of a number of entities associated with the organization and a second quantity of internal-obtainment units for a second of the number of entities associated with the organization; and
allocating the product to one of the number of entities associated with the organization.

15. The method of claim 14, wherein the first quantity of internal-obtainment units is different than the second quantity of internal-obtainment units.
